(19) United States
(12) Patent Application Publication
(10) Pub. No.: US 2014/0058936 A1
(43) Pub. Date: Feb. 27, 2014

(54) MANAGING VIRTUAL WALLETS PROVIDED BY A MOBILE TERMINAL

(71) Applicant: Deutsche Telekom AG, (US)

(72) Inventors: Zhiyun REN, Berlin (DE); Joerg HEUER, Berlin (DE); Ming YIN, Berlin (DE); Klaus-Peter HOFMANN, Berlin (DE)

(73) Assignee: DEUTSCHE TELEKOM AG, Bonn (DE)

(21) Appl. No.: 13/761,325

(22) Filed: Feb. 7, 2013

(30) Foreign Application Priority Data
Feb. 9, 2012 (EP) 12 075 012.0

(51) Int. Cl. G06Q 20/36

(52) U.S. Cl. CPC G06Q 20/36
USPC 705/41

(57) ABSTRACT

A method for managing a plurality of virtual wallets provided by a mobile terminal for carrying out transactions with electronic devices. The plurality of virtual wallets receives different virtual objects and manages resources available via the different virtual objects. Each virtual wallet of the plurality of virtual wallets includes a respective security element connected to the mobile terminal used for identification in a transaction and a respective wallet application for controlling transactions and providing a user interface for a user of the mobile terminal. The plurality of virtual wallets are linked and displayed by a unitary wallet application. The method includes accessing, by the unitary wallet application, a security element of a virtual wallet for a transaction via a hardware control interface supported by the mobile terminal that is universal to the respective security elements of the plurality of virtual wallets.

### CROSS-REFERENCE TO RELATED APPLICATIONS

This application claims priority to European Patent Application No. 12 075 012.0, filed Feb. 9, 2012, which is hereby incorporated by reference herein in its entirety.

### FIELD

The invention relates to a method for managing virtual wallets, also known as mobile wallets or e-wallets, which make possible cashless payment processes and comparable commercial or monetary or even security-related transaction processes, using a mobile terminal. In this context, the security-related transaction processes may for example be key management for cryptographic applications or transaction processes for access to protected items of information or admission to protected, access-controlled areas.

### BACKGROUND

A mobile wallet of this type is a module, formed from a combination of hardware and software, within a mobile terminal such as a mobile telephone or a smartphone. The aforementioned module basically includes two components, specifically a hardware-based security element and a software-based wallet application which can be executed by a processing unit of the mobile terminal. In this context, the security element is used in particular for identification during payment or transaction processes which are to be carried out by means of the corresponding mobile terminal. The security element is for example the SIM card of a mobile telephone or another chip card which is received in the mobile terminal, such as a UICC (universal integrated circuit card). Moreover, however, the security element may also be a Java card which is integrated into the chipset of the mobile terminal or mobile telephone. On the security elements or chip cards, there are applets which handle items of information or keys, which are used for identification, and data which is stored encrypted on the chip card. These applets—in connection with Java it is also possible to refer to Java cardlets, to some extent conflating the concepts of “card” and “applet”—may be addressed both by the associated wallet application and when payment processes are carried out at acceptance points, in particular wirelessly at the point of sale (PoS), specifically by way of radio-assisted near field communication (NFC).

By way of the software (wallet application) which cooperates with the security element of a mobile wallet, the virtual wallet is displayed in an appropriate form (preferably in a graphical form on a display) to a user who is using the mobile terminal Further, payment processes or transaction processes which are carried out using the corresponding mobile wallet or a virtual wallet are controlled by the software while accessing the associated security element. A mobile wallet which is formed in the manner described above is disclosed for example in EP 2 369 543 A1.

With many mobile terminals, such as modern smartphones in particular, a plurality of virtual wallets of this type can be managed, each using a different security element. Thus, as well as a SIM card from a mobile communications provider, some smartphones may receive at least one further chip card (for example an expanded-functionality SD card). Further, it is more common to come across the integration of corresponding functionalities (in particular the aforementioned applets), preferably in the form of a Java card, into the chipset of the mobile terminal.

On the other hand, the cashless payment systems or transaction systems of different providers are generally only configured for one of the aforementioned security elements. Thus, for example, a ticketing system in which train tickets or theatre tickets can be purchased by cashless transaction using the mobile terminal may use the SIM card of mobile telephones or smartphones as a hardware-based security element. By contrast, credit card companies who support a cashless payment using mobile terminals, for example, may rely on a Java card integrated into the chipset thereof. However, the architecture of modern mobile terminals is usually configured in such a way that in each case only one security element, possibly out of a plurality of security elements, can ever be active; that is to say, it is not possible to access a plurality of security elements simultaneously. In this context, in each case there is a software-based wallet application which cooperates with or is responsible for the respective security element when forming a mobile wallet. However, this means that at an acceptance point, for cashless payment processes or transactions which are to be carried out using the relevant terminal, or at the point of sale, the user of a mobile terminal equipped with a plurality of mobile wallets has to select the mobile wallet which is respectively supported by the relevant provider of a cashless payment on his mobile terminal himself, but in particular has to activate the associated security element thereof. In this context, he may in some cases be assisted by user interfaces (UIs), which list the security elements available to him in the mobile terminal which he is using. By referring to the relevant list, he can subsequently select the respectively relevant security element and thus the mobile wallet which is to be used for a payment process, but he has to activate the security element himself by way of corresponding operating processes. Thus, handling a plurality of different mobile wallets on a mobile terminal is often difficult for the user to understand, in spite of the aforementioned assistance. In this context, in some cases the user also has to search through a plurality of the mobile wallets stored on his mobile terminal before he can establish which one manages for example the cashless means of payment accepted at the point of sale. Since only the security element which is actually active via NFC in each case and the virtual objects located thereon, such as virtualised means of payment, are visible to the relevant acceptance point, the user may also further have to switch from one mobile wallet to the other mobile wallet which contains the corresponding virtual objects such as cashless means of payment. It is not uncommon for users to be unable to cope with this.

### SUMMARY

In an embodiment, the present invention provides a method for managing a plurality of virtual wallets provided by a mobile terminal for carrying out transactions with electronic devices. The plurality of virtual wallets receives different virtual objects and manages resources available via the different virtual objects. Each virtual wallet of the plurality of virtual wallets includes a respective security element connected to the mobile terminal used for identification in a cashless transaction process and a respective wallet application for controlling the cashless transaction process and for displaying the virtual wallet on the mobile terminal for interaction with a user of the mobile terminal. The plurality of virtual wallets are linked and displayed by a unitary wallet application. The method includes: accessing, by the unitary wallet application, the respective security element of a virtual wallet for the cashless transaction process via a hardware control interface supported by the mobile terminal that is universal to the respective security elements of the plurality of virtual wallets.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic drawing of a mobile device which provides virtual wallets, for illustrating a first basic embodiment of the invention,

FIG. 2 is a schematic drawing comparable with FIG. 1 for illustrating a further basic embodiment of the invention.

### DETAILED DESCRIPTION

In an embodiment, the present invention provides a solution which makes it possible for the user of a mobile terminal, equipped with various virtual wallets, to handle these wallets in a flexible manner, in particular without having to think, in connection with a payment or transaction process, about which of these virtual wallets manages the virtual object respectively required for the corresponding process, such as a cashless means of payment, and how to activate the associate hardware-based security element when switching to the corresponding virtual wallet.

In an embodiment, a method according to the present invention involves a virtual wallet which receives different virtual objects, such as cashless means of payment in particular, and by way of these virtual objects manages available resources, such as amounts of money, in the form of data which represent them. Furthermore, corresponding data which represent resources are transmitted to other electronic devices, formed for receiving and further processing these data, by way of a virtual wallet, provided by a mobile terminal, for carrying out cashless payment processes or other transaction processes of the type mentioned at the outset. Finally, the overall system in which a corresponding virtual wallet of this type is included further comprises corresponding back end systems, the issuer of virtual objects which are to be received by the virtual wallets, such as cashless means of payment, or by operators of payment systems or transaction systems. These back end systems may for example be the computer systems of credit card companies which participate in cashless monetary transactions, in particular in transactions using virtual means of payment, or servers of service providers who offer their services by carrying out security-related or monetary transaction processes, such as what is known as ticketing. The relevant back end system may also for example be used for recording payment processes and for example for balance calculations for virtualised credit cards which are received by the virtual wallets.

In complex commercial processes, such as the aforementioned ticketing, the actual payment process may take place somewhat in advance of a transaction process which takes place using the mobile terminal—in this case the use of the mobile terminal or mobile telephone as an entry ticket or train ticket—and in which the mobile terminal transmits data, for checking the validity of a ticket having monetary value, to a corresponding electronic device. Nevertheless, the use of the ticket and the transmission of data for checking the validity thereof constitute a transaction process comparable with a cashless payment process using a virtual credit card. With regard to the above example, it is even conceivable in this context for a corresponding ticket to be purchased using a cashless means of payment, which is stored in a first virtual wallet of the mobile terminal and is associated with a credit card, and subsequently to be received as a credential or virtual ticket by another virtual wallet, which is provided by the same mobile terminal. In this context, in accordance with this understanding, corresponding credentials or else coupons or the like constitute virtual objects which can be received, comparably with cashless means of payment, by in each case one of the virtual wallets provided by the mobile terminal. In accordance with this understanding, amounts of money which are available via cashless means of payment, and other resources which are managed in the virtual wallets, also comprise data of this type, which are transmitted to other electronic devices for example in connection with the purchase or use of coupons or discounts or for implementing refund systems involving the corresponding mobile terminal.

It should be noted that, unless otherwise specified, a mobile terminal (as used in the content of the method according to the invention) should be understood to mean a mobile terminal (for example a mobile telephone, smartphone or tablet) which provides virtual wallets. So as to differentiate, other devices which are involved in cashless payment process and transaction processes, such as a checkout device used at the point of sale to carry out cashless payment processes by way of near field communication, are generally referred to as electronic devices.

In an embodiment, each of the wallets provided by the mobile terminal respectively includes a hardware-based security element, which is used for identification in payment processes or other transaction processes and is connected to the mobile terminal, and a software-based wallet application. Said application in particular displays the virtual wallets provided by the mobile terminal, for interaction with a user who is using them, and controls cashless payment processes and transaction processes by accessing the security element associated with the virtual wallet which is used in the respective case. This wallet application is software which can be executed by a processing unit of the relevant mobile terminal, each tablet and each smartphone having a processor which preferably acts as a processing unit of this type in this context.

The hardware-based security element associated with a virtual wallet may be of various forms. It is a SIM card received by a smartphone, a UICC or another chip card received by the mobile terminal, or else possibly even at least one corresponding functional element which is integrated into the chipset of the mobile terminal. In each case, a security element of this type is also equipped with a firmware or an applet or cardlet, which makes interaction with an associated wallet application possible. In this context, the relevant wallet application comprises a hardware control interface for physical access to the corresponding security element. In this context, the communication between the wallet application and the security element, specifically the exchange of corresponding data related to the operation of the virtual wallet, takes place using Java applications, the aforementioned Java cardlets, which are supported by the corresponding security element.

In an embodiment, a virtual wallet is released by the user thereof who is using the mobile terminal or smartphone, and the convenience of use of different virtual wallets and thus of different security elements is increased in that all of the virtual wallets provided by the relevant mobile terminal are represented by a unitary software-based wallet application, specifically irrespective of the security element respectively linked with each virtual wallet. For simplicity, this unitary wallet application will be referred to in the following as a multi-wallet, in such a way that in the following explanations of the invention, the term “multi-wallet” is used synonymously with the term “unitary wallet application”. In this context, the corresponding, preferably visual display of the wallets via this multi-wallet also includes managing virtual objects which are contained in these wallets and resources which are available via these objects.

In an embodiment, the aforementioned multi-wallet, that is to say the unitary wallet application for all of the wallets and all of the security elements, accesses the security element of a virtual wallet used for a payment or transaction process directly via a hardware control interface which is universal to the security elements supported by the mobile terminal In another embodiment, the access, required in a payment or transaction process, to the security element of the virtual wallet used for this purpose takes place via a wallet application configured specifically for the respective security element, the multi-wallet and the aforementioned wallet application configured specifically for one security element interacting via a shared programming interface, and the wallet application specific to one security element having a hardware control interface for access to the relevant security element. For simplicity and to some extent for contrast with the multi-wallet, this second wallet application of a provider of a solution for a virtual wallet, configured specifically for one security element, or the corresponding software, linked to a specific security element, is to be referred to in the following as a single wallet. In this connection, it should again be expressly noted at this point that a mobile wallet, that is to say a virtual wallet, is a module including two components, specifically a hardware component (security element) and a software component (wallet application), whereas the components denoted for simplicity merely as a wallet, specifically a multi-wallet on the one hand and a single wallet on the other hand, refer to software-based applications as part of a multi-wallet, that is to say of a virtual wallet.

In accordance with an advantageous embodiment of the method according to the invention, items of information on different virtual wallets and for graphically displaying them are managed in a database which is associated with the multi-wallet and from which said items of information are also linked to details of a respective virtual object received by the relevant virtual wallet, such as in particular a cashless means of payment. This embodiment is advantageously developed in that the aforementioned database can be configured, administered and updated by the user of the mobile terminal. Thus, the user can for example receive items of information on virtual wallets recently brought into circulation, or virtual objects for these virtual wallets, to the database by actuating corresponding update processes, in which a connection is made to a corresponding portal providing these items of information and the relevant items of information are downloaded.

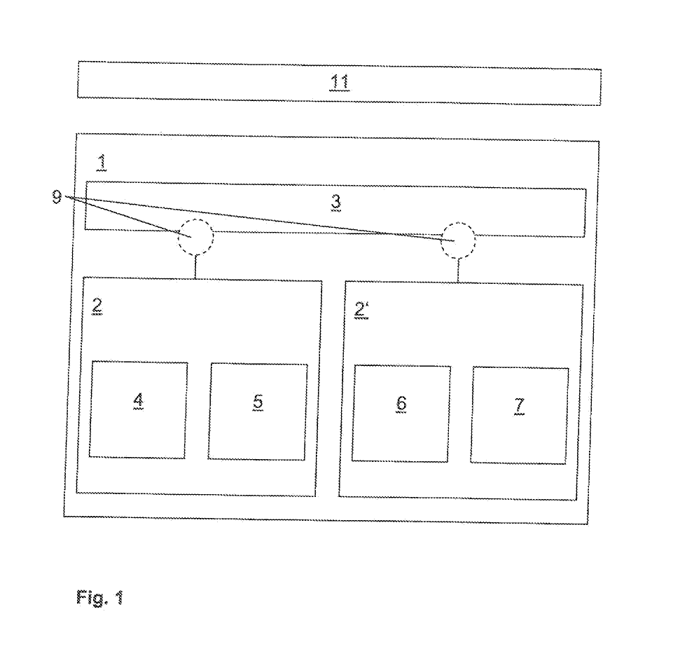

FIG. 1 is a schematic drawing of a mobile terminal 1, for example a mobile telephone or smartphone. The following is based on a smartphone which provides a plurality of mobile wallets or virtual wallets for use in cashless payment processes or in transaction processes. In this context, the drawing depicts the hardware and software components of the virtual wallets provided by the smartphone 1. These components, illustrated symbolically in the drawing, represent both software-based and hardware-based components. The drawing also symbolically illustrates an electronic device 11 at an acceptance point of a point of sale (PoS), which acceptance point supports and accepts cashless payments and transaction processes, which take place by way of data exchange between the mobile terminal 1 and the electrical device 11 using near field communication (NFC). The smartphone 1 which is symbolically illustrated by way of example provides two virtual wallets, although it is obviously also possible for the smartphone 1 to provide a larger number of virtual wallets. The virtual wallets are preferably configured to receive different virtual objects 4, 5, 6, 7, such as cashless means of payment. Thus for example the first hardware-based security element 2, shown on the left in the drawing, or the virtual wallet implemented thereby receives different virtual objects 4, 5, such as cashless means of payment in the form of different credit cards, which are virtualised by the relevant security element 2 for the purpose of identification in payment or transaction processes. The other hardware-based security element 2′ (to the right in the drawing) may for example be the part of a virtual wallet which is involved in a ticketing system and receives corresponding tickets, purchased using this ticketing system, as virtual objects 6, 7 having a monetary value, and thus to some extent also receives cashless means of payment or means equivalent to means of payment of this type.

In the prior art, for a cashless payment process or a transaction, in each case the user of the smartphone 1 would have to select the virtual wallet which could be used for this purpose, as visualised by a special wallet application, that is to say a single wallet, and activate the associated security element 2, 2′. However, this would mean that once he has eventually carried out a cashless payment process by means of his smartphone 1, using a credit card 4, 5 associated with the first security element 2 shown on the left, if he subsequently wishes to use the smartphone 1 for entry to a concert event by means of a virtual ticket 6, 7 associated with the right-hand security element 2, the user has to be aware that in this case he needs to operate the virtual wallet having access to the second security element 2′ shown on the right, and that he has to activate this security element 2′ by way of corresponding operating processes on the smartphone 1.

However, this becomes unnecessary as a result of using the solution according to the invention. As is illustrated in the drawing, the smartphone 1 of the user comprises a multi-wallet 3 for this purpose, specifically a software-based wallet application which is also unitary with regard to different security elements 2, 2′. In a cashless payment process or in a transaction process, this multi-wallet 3 automatically accesses the security element 2, 2′ which is to be used for this purpose. For this purpose, the multi-wallet 3 has a universal hardware control interface 9, via which different security elements 2, 2′ can be linked so as to implement a plurality of virtual wallets. The provider of a cashless payment system merely has to establish by means of which hardware-based security element 2, 2′ the user of the provider's system is to identify himself in payment or transaction processes. In turn, the manufacturer of the relevant security element 2, 2′ merely has to configure it in accordance with the specifications of the hardware control interface 9 of the multi-wallet 3, or a company which provides the multi-wallet 3 merely has to implement hardware control interfaces 9, which are already established on the market, for corresponding security elements 2, 2′ in the corresponding software.

The process sequences for adding a virtual object 4, 5, 6, 7, such as a cashless means of payment (a card, that is to say a credit card, store card, discount card, ticket and the like), to a virtual wallet of the smartphone 1, for removing a virtual object 4, 5, 6, 7 of this type, for activating or deactivating it and for using the virtual objects 4, 5, 6, 7 are configured as described in the following.
Adding a virtual object into a virtual wallet
   1. A new service or a new virtual object 4, 5, 6, 7, such as a cashless means of payment, is loaded onto one of the security elements 2, 2′
   2. Via functions of the relevant security element 2, 2′ (cardlet), the multi-wallet gains knowledge of the new virtual object 4, 5, 6, 7
   3. The multi-wallet 3 reloads the items of information for graphically representing the virtual object 4, 5, 6, 7 from a system (for example the back end system) of the issuer, preferably “over the air”, and links said items of information with the application (applet) on the specific security element 2, 2′ in a database stored on the smartphone 1.
Removing a virtual object from a virtual wallet
   1. In the multi-wallet 3, the user selects a virtual object 4, 5, 6, 7 which is to be deleted, such as a card (for example a virtual credit card) or a cashless means of payment
   2. The multi-wallet 3 transmits, to the back end system of the issuer or the operator company, a message that the applet associated with the virtual object 4, 5, 6, 7 or the card or the cashless means of payment on the security element 2, 2′ is to be deleted
   3. Once the back end system has deleted the applet, the multi-wallet 3 finds out about the removal of the applet via sequences on the relevant security element 2, 2′ (in the form of an event mechanism or the like)
   4. The multi-wallet 3 subsequently removes the associated graphical representation and the link to the associated security element 2, 2′ from the internal database thereof.
Activating or deactivating a virtual object in a virtual wallet
   1. By means of the multi-wallet 3, the user selects a virtual object 4, 5, 6, 7, for example a cashless means of payment, for activation or deactivation
   2. The multi-wallet 3 establishes, by means of the internal database, which security element the relevant virtual object 4, 5, 6, 7 is associated with
   3. Subsequently, the multi-wallet 3 initially selects the relevant security element 2, 2′ and subsequently addresses the corresponding application (applet) and sends a command to activate or deactivate the virtual object 4, 5, 6, 7, for example the cashless means of payment
   4. In addition, the security element 2, 2′ is activated for use at the PoS.
Use of a virtual object at an acceptance point (PoS, card reader)
   1. The user initially activates the virtual object 4, 5, 6, 7, for example the cashless means of payment, which he would like to use in the subsequent transaction
   2. The user holds the smartphone 1 within the NFC range of the card reader of the electronic device 11 of the PoS, for example a checkout device
   3. The PoS or the corresponding checkout device 11 selects the desired application (applet) on the currently active security element 2, 2′ and interacts therewith so as to carry out the desired transaction
   4. The user removes his smartphone 1 from the checkout device 11 at the PoS again.

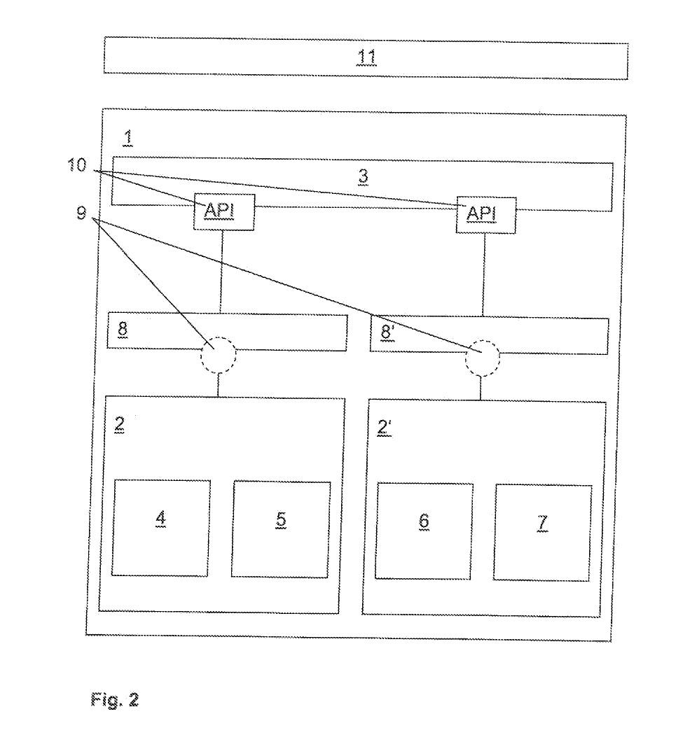

FIG. 2 is a schematic drawing comparable with FIG. 1 of a configuration in accordance with a second basic embodiment of the invention. In this embodiment, as is known from the prior art, each security element 2, 2′ is assigned a wallet application, that is to say a single wallet 8, 8′, which is specifically tailored to this security element 2, 2′. The single wallets 8, 8′ have a standardised programming interface 10 (application programming interface—API), via which they communicate with the superordinate multi-wallet 3, and each have a hardware control interface 9 for access to the associated security element 2, 2′. In this case too, the user of the smartphone 1, when using it for a cashless payment or transaction process, does not have to think about which of the virtual wallets provided by his smartphone 1 is to be used for this purpose or which of the hardware-based security elements 2, 2′ is accordingly to be activated. This is instead implemented by the multi-wallet 3, which displays all of the virtual objects 4, 5, 6, 7 received by the various virtual wallets thereof, such as cashless means of payment, for corresponding interaction, preferably on a display of the smartphone 1. The processes of adding or deleting and activating or deactivating and using a card or a virtual object 4, 5, 6, 7, which has been received by a corresponding virtual wallet on the smartphone 1, are configured as described in the following.
Adding a virtual object into a virtual wallet
   1. A new service (for example from a card supplier) or a new virtual object 4, 5, 6, 7, such as a cashless means of payment, is loaded onto one of the security elements 2, 2′
   2. Via functions of the relevant security element 2, 2′ (cardlet), the associated single wallet 8, 8′ which is specific to one security element gains knowledge of the new cashless means of payment 4, 5, 6, 7
   3. The single wallet 8, 8′ reloads the items of information for the graphical display, and links said items of information with the application on the specific security element 2, 2′ in a database stored on the smartphone 1
   4. The single wallet 8, 8′ additionally informs the superordinate multi-wallet 3 about the new virtual object 4, 5, 6, 7, such as a new cashless means of payment, in such a way that said multi-wallet can incorporate the corresponding items of information into its own database.
Removing a virtual object from a virtual wallet
   1. In the multi-wallet 3, the user selects a virtual object 4, 5, 6, 7 which is to be deleted, such as a cashless means of payment or a virtual credit card
   2. The multi-wallet 3 transmits, to the back end system of the issuer or the operator company, a message that the applet associated with the virtual object 4, 5, 6, 7 on the security element 2, 2′ is to be deleted
   3. Once the back end system has deleted the applet, the single wallet 8, 8′ finds out about the removal of the applet via sequences on the relevant security element 2, 2′ (in the form of an event mechanism or the like)
   4. The single wallet 8, 8′ subsequently removes the associated graphical representation from the internal database thereof
   5. The single wallet 8, 8′ additionally informs the superordinate multi-wallet 3 about the removal of the virtual object 4, 5, 6, 7, for example a cashless means of payment or a virtual credit card, in such a way that said multi-wallet can amend the corresponding items of information in its own database.
Activating or deactivating a virtual object in a virtual wallet
   1. By means of the multi-wallet 3, the user selects a virtual object 4, 5, 6, 7, for example a cashless means of payment or a virtual credit card, for activation or deactivation
   2. The multi-wallet 3 establishes, by means of the internal database, which security element 2, 2′ the relevant virtual object is associated with
   3. Subsequently, the multi-wallet 3 initially selects the relevant security element 2, 2′ and subsequently addresses the corresponding application (applet) stored by the security element 2, 2′ and sends a command to activate or deactivate the virtual object 4, 5, 6, 7 via the programming interface 10, the corresponding single wallet 8, 8′ and the hardware control interface 9 thereof
   4. In addition, the security element 2, 2′ is activated for use at the PoS.
Use of a virtual object at an acceptance point (PoS, card reader)
   1. The user initially activates the virtual object 4, 5, 6, 7, for example a cashless means of payment, which he would like to use in the subsequent transaction
   2. The user holds the smartphone 1 within the NFC range of the card reader of a checkout device (electronic device 11 at the PoS)
   3. The PoS or the corresponding checkout device 11 selects the desired application (applet) on the currently active security element 2, 2′ and interacts therewith so as to carry out the desired transaction
   4. The user removes his smartphone 1 from the PoS again.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

### LIST OF REFERENCE NUMERALS

1 mobile terminal, for example smartphone
2 hardware-based security element
3 unitary wallet application, multi-wallet
4, 5, 6, 7 virtual object, for example cashless means of payment
8, 8′ wallet application which is specific to one security element, single wallet
9 hardware control interface
10 programming interface
11 electronic device, for example checkout device at the PoS

1. A method for managing a plurality of virtual wallets provided by a mobile terminal for carrying out transactions with electronic devices, wherein the plurality of virtual wallets receives different virtual objects and manages resources available via the different virtual objects, wherein each virtual wallet of the plurality of virtual wallets includes a respective security element connected to the mobile terminal used for identification in cashless transaction process and a respective software-based wallet application for controlling the cashless transaction process and for displaying the virtual wallet on the mobile terminal for interaction with a user of the mobile terminal, and wherein the plurality of virtual wallets are linked and displayed by a unitary wallet application, the method comprising:
accessing, by the unitary wallet application, the respective security element of a virtual wallet for the cashless transaction process via a hardware control interface supported by the mobile terminal that is universal to the respective security elements of the plurality of virtual wallets.

2. The method of claim 1, wherein the different virtual objects include at least one of virtualized payment of virtualized credit cards.

3. The method of claim 1, wherein the resources managed by the plurality of virtual wallets include amounts of money in the form of transmittable data so as to carry out the cashless transaction process.

4. The method according to claim 1, wherein items of information on different virtual wallets and information related to graphically displaying the items of information are managed in a database associated with the unitary wallet application, said items of information being linked to details of respective virtual objects received by respective virtual wallets.

5. The method according to claim 4, wherein the database is administered and updated by the user of the mobile terminal.

6. The method according to claim 5, wherein the database is capable of being configured, administered and updated by the mobile terminal containing the database.

7. A method for managing a plurality of virtual wallets provided by a mobile terminal for carrying out transactions with electronic devices, wherein the plurality of virtual wallets receives different virtual objects and manages resources available via the different virtual objects, wherein each virtual wallet of the plurality of virtual wallets includes a respective security element connected to the mobile terminal used for identification in a cashless transaction process and a respective software-based wallet application for controlling the cashless transaction process and for displaying the virtual wallet on the mobile terminal for interaction with a user of the mobile terminal, and wherein the plurality of virtual wallets are linked and displayed by a unitary wallet application, the method comprising:
accessing, by the unitary wallet application, the respective security element of a virtual wallet for the cashless transaction process via a programming interface between the unitary wallet application and the wallet application of the virtual wallet, wherein the virtual wallet is equipped with a hardware control interface for access to the security element of the virtual wallet, and wherein the wallet application is configured specifically for the security element.

8. The method according to claim 7, wherein the different virtual objects include at least one of virtualized payment or virtualized credit cards.

9. The method according to claim 7, wherein the resources managed by the plurality of virtual wallets include amounts of money in the form of transmittable data so as to carry out the cashless transaction processes.

10. The method according to claim 7, wherein items of information on different virtual wallets and information related to graphically displaying the items of information are managed in a database associated with the unitary wallet application, said items of information being linked to details of respective virtual objects received by respective virtual wallets.

11. The method according to claim 8, wherein the database is administered and updated by the user of the mobile terminal.

12. The method according to claim 9, wherein the database is capable of being configured, administered and updated by the mobile terminal containing the database.
